(19) United States
(12) Patent Application Publication
(10) Pub. No.: US 2006/0174763 A1
(43) Pub. Date: Aug. 10, 2006

(54) Self cleaning electrostatic air cleaning system

(75) Inventors: Robert P. Scaringe, Rockledge, FL (US); Dwight Back, Rockledge, FL (US)

Correspondence Address: CROWELL & MORING LLP;INTELLECTUAL PROPERTY GROUP, P.O. BOX 14300, WASHINGTON, DC, 20044-4300, US

(73) Assignee: Mainstream Engineering Corporation, Rockledge, FL (US)

(21) Appl. No.: 11/049,668

(22) Filed: Feb. 4, 2005

(51) Int. Cl. B03C 3/00

(52) U.S. Cl. 95/57

(57) ABSTRACT

A self-cleaning air purifier for use with a central air conditioning device includes at least one ion generator made up of at least one ionizer bar and an electrically grounded water reservoir with an exposed surface, where the surface of the water is parallel and proximate to the at least one ionizer bar. Contaminants in the air flow path are charged and driven to the grounded water surface. This grounded water surface (ground plane) is comprised of a container with a submerged grounding plate or is comprised of a grounded electrically conducting container. The grounding plate may also be comprised of metals such as Cu, Zn, Sn, Ni, and Ag, or alloys containing these metals, which will also act as biocides in the water. Materials such as tablets or packets may also be added to the electrically grounded water reservoir so as to provide the biocide materials. The tablets or packets can be comprised of metal biocide salts with chelating agents to retain the dissolved biocide metals in solution.

### BACKGROUND OF THE INVENTION

This invention relates to a self-cleaning electrostatic air cleaning system for air conditioning and heating systems.

U.S. Pat. No. 6,126,722 describes an electrostatic reduction system for reducing airborne dust and microorganisms which uses a negative air ionizer bar and a ground plane which is parallel and proximate to the ionizer bar. Also disclosed is a dust collection device such as a tray containing an aqueous composition optionally containing a degreaser, which helps wet the collected particles allowing them to settle to the bottom of the dust collection device. Another embodiment of the prior art dust collector includes grounded metal dust collector plates attached to the back wall of hatching cabinet with water spray nozzles which are mounted above or beside the plate for washing the collector plates.

Yet another embodiment is described in said U.S. patent for use in small commercial hatching cabinets, and includes ionizer bars 11 proximate to ground plane 4 and at least two grounded dust collection devices containing water and a degreaser 7 (FIGS. 2 and 3). A grounded water tray 8 is placed in the bottom of cabinet 9 (FIG. 3). A second upper tray 8 is located beneath bars 11 and a ground plane 4 which is attached to frame 6 is located proximate to the ionizer bars. Typically, frame 6 with legs sits in upper tray 8 (FIG. 2). Trays 8 are filled to a depth of at least about one inch with water and a degreaser composition.

Hoenig et al (Foundrymens Soc. Transactions, Volume 84, 55-64, 1976) discloses a charged spray to reduce silica sand dust from 20 mg/m³ to 2 mg/M³ with positively charged water fog.

U.S. Pat. No. 3,696,791 discloses the use of air ionization for reducing air-borne particulates and ammonia gas and odors in feeding enclosures of animals, especially poultry. U.S. Pat. Nos. 4,388,667; 4,390,923; and 4,493,289 disclose devices for reducing air-borne particulates and ammonia gas and odors in feeding enclosures of animals, especially poultry, using air ionization, and including a voltage generator and a control device. The devices are grounded so that negatively charged particles are attracted to deck surfaces. The '667 patent discloses an apparatus similar to the one disclosed in the '289 patent which applies positive voltage to one electrically conducive cable and negative voltage to a second electrically conducive cable in order to control static charge, eliminate arching, and control net ion flux in animal or poultry zones.

U.S. Pat. No. 4,326,454 discloses ion dispensers which are supported on an extended carrier that defines the electrostatically charged surfaces. A groundable extended metallic surface may be associated with the carrier surface. This metallic surface may be defined by the wall of the chamber containing the dispenser. U.S. Pat. No. 6,494,934 B2 discloses an air cleaner having a negative ion generator and a positive electrode, and may have an absorbing sheet positioned close to the positive electrode. U.S. Pat. No. 6,432,367 B1 discloses an air cleaner for use with a heating, ventilating, and air conditioning system that uses a first processing state which includes a fogging array of fogging transducers to introduce water as uniformly dispersed fog and cause water droplets to mix with said air stream as a means of reacting with nitrogen dioxide and ozone eventually resulting in their removal from the air stream. U.S. Pat. No. 6,656,253 B2 discloses an apparatus for removing particles from air wherein a charged spray of semiconducting fluid droplets are introduced into the air so that the particles are electrostatically attracted to and retained by the spray droplets. In this patent, the semiconducting fluid is recirculated until the fluid becomes too contaminated to be used.

It is well known in the art that the use of a positively or negatively charged ionization tip can charge the contaminants in the air and cause these particles to be attached to an object of the opposite or grounded (neutral) polarity. These systems have, however, always been burdened with the problem of cleaning a filter, collection surface or collection tray. A water spray system for cleaning the collector surface, for example, has been proposed. U.S. Pat. No. 6,679,940 B1 also discloses a pre-filter mounted on the front surface of an ionization and dust collection unit so that the ionization section need not be removed for cleaning because this process can damage the ionization wires.

### SUMMARY OF THE INVENTION

While various methods are known for simplifying the cleaning of charged ion air cleaning devices, the present invention provides a simple method of continuously cleaning the collection body of the air cleaner in which the collection body is the exposed two-dimensional free surface of a flowing water stream and the three-dimensional water body which is not recirculated. This water stream is a result of the condensation of water in the evaporator section of an operating air conditioning unit (or the excess water flow from a humidifier unit of a forced air heating system, this flow being necessary to prevent calcium and other mineral deposits from accumulated on the humidifier surfaces), and in either case this water would normally be discarded anyway, so this invention advantageously uses this condensed or excess water before being discarded. The disclosed self-cleaning device is located anywhere below the evaporator drain pan (or humidifier outlet), so that gravity can be used to force the flow of water through the self-cleaning air cleaner.

While a pump can also be used to accomplish the aforementioned task and is within the contemplation of the present invention, the use of gravity makes this system even simpler and more reliable. The grounded collector surface is the water surface (with a ground electrode submersed in the water, or using a conductive and grounded open water container) or the water body, and this water is continually changed by the flow of condensate from the evaporator's drain pan (or the flow of excess water from the humidifier).

The present invention uses the grounded water tray below the ionization tips as the ground plane, and has a continuous flow of air conditioning condensate water (or excess humidifier water flow during heating system operation) continually carrying the trapped impurities away. There is only one grounded tray located directly below the ionization tips, i.e., there is no other ground plane or additional grounded tray. The need for surfactant or degreaser as in U.S. Pat. No. 6,126,722 has been avoided because we do not want the contaminants to settle out, but rather to remain trapped on the surface or within the three-dimensional water body. This invention also teaches the use of metal biocides in the electrically grounded water as a mechanism to disinfect the water, as well as the generation of ozone at low concentrations to disinfect the air passing through the device.

It is therefore an object of the present invention to provide a dust/particulate reduction system for reducing airborne contaminants in the air duct of operating air conditioning and forced air heating systems in which the existing evaporator condensate flow (or humidifier excess water flow) is used to continuously remove the captured contaminates. “Dust/particulate” is hereby defined to include any entity which can be airborne including metal particles, organic particles, microbes (mold, fungi, bacterium, virus), and debris such as feces and skeletal dust (e.g., dust mites).

The optimum spacing for a particular power supply capacity and output voltage has been found to lie between the maximum (no ion flow) and minimum (arcing) boundaries such that the desired setting can now be easily determined by one skilled in the art, based on the relative amounts of air purification and ozone generation desired as well as on the total power to be consumed and the energy efficiency desired in the resulting device. Ozone is generated by this device at low concentrations, and is diluted below the maximum allowable concentration of 0.050 ppm recommended by ASHRAE in an air conditions and ventilated space.

The system can employ a known type of a non-conductive frame for supporting the at least one ionizing tip. (This frame could be a continuation of the water container if a non-conducting container was used or a separate external frame can be used. This frame must be sufficiently open to allow air to easily pass between the ionizing tip and the water surface.)

It is therefore a further object of the present invention to provide a self-cleaning air purification and dust reduction system for reducing air borne contaminants in conditioned enclosed spaces, that includes at least one negative air ion generator bar that has at least one ionizing tip and a flowing water grounded body which has a surface perpendicular and proximate to the at least one ionizing tip and which is fed by the condensation of the moisture removed from the conditioned air, by the evaporator of an operating air conditioning system. (or by the excess water flow from a heating system's humidifier.) This system need only be operated when the air conditioner (or heating system) is operating, and is therefore wired so as to provide electrical input power to the power supply only when the blower of the air handler and the AC compressor (or heating system) is operating.

Yet another object of this invention is to provide disinfection of the flowing grounded water with metal biocides.

Still another object of this invention is provide disinfection of the flowing grounded water by the formation of ozone which is created by the flow of ions from the at least one ionizing tip and into the grounded water body.

A still further object of this invention is to provide ozone disinfection of the air passing through the device by the production of ozone created by the flow of ions from the at least one ionizing tip and into the grounded water body.

Another object of the present invention is to provide a three-dimensional, grounded collection body, for collection of an even higher mass of dust/particulates than was heretofore achievable with known systems having only a two dimensional surface (e.g., metal plates).

An advantage of the present invention is that it can also be used to reduce or eliminate airborne microbes such as mold spores, fungi, virus, and bacterium. Examples of airborne microbes include Mycobacterium tuberculosis, anthrax, Staphylococcus aureus, Coxsackie B virus, chickenpox virus (Varicella zoster), smallpox virus (Poxvirus variola), whooping cough bacteria (Bordetella pertussis), pneumonia bacteria (Mycoplasma pneumoniae), bronchitis bacteria (Chlamydia pneumoniae), meningitis bacteria (Haemophilus influenzae), diphtheria bacteria (Corynebacteria diphtheria), scarlet fever bacteria (Streptococcus pyogenes), otitis media bacteria (Streptococcus pneumoniae), as well as various molds and fungi. It is also contemplated that this invention could be used to remove dust mites and dust mite feces or skeletal remains from air.

### BRIEF DESCRIPTION OF THE DRAWINGS

Further objects, features and advantages of the invention will become apparent from the following detailed description when taken in conjunction with the accompanying drawings wherein.

FIG. 1 is a schematic elevation view of the self cleaning air cleaner of the present invention which is comprised of at least one ionizing tip on the at least one ion generator bar. This ionizing assembly is charged to a negative or positive voltage of at least 10,000 volts, from a high voltage power supply 100. The electric charge is transferred to air contaminants as they flow past the at least one ionization tip. The charged contaminants are then attracted to the nearby grounded flowing water surface 40 and may disperse into the water body 41.

FIG. 2 is a schematic elevation view showing the self-cleaning air cleaner of FIG. 1 installed in the return air duct of a new or existing air handler of an air conditioning or heating system. To avoid the need for any water circulation pumps the self-cleaning air cleaner is located below the condensate drain pan 131, (or below the heating system humidifier) so that condensate water can drain by gravity into the collection tray and then out of the system.

FIG. 3 is a view similar to FIG. 1 but showing the use of biocide tablets or packets to disinfect the grounded water.

FIG. 4 is a plot of the voltage as a function of distance between the ion generator bar and the surface of the water in the grounded water body 41 for one particular high-voltage power supply.

FIG. 5 is a plot of the amperage produced by the flowing of negative ions as a function of the distance between the ion generator bar and the surface of the water in the grounded water body for the same high-voltage power supply applicable to FIG. 4.

FIG. 6 is a plot of the consumed electrical power to provide the flow of negative ions as a function of distance between the ion generator bar and the surface of the water in the grounded water body for the same high-voltage power supply of FIG. 4.

FIG. 7 is a schematic elevation view of another embodiment of a self-cleaning device according to the present invention which utilizes a wetted sponge, gel, absorbent or adsorbent material as the grounding electrode.

FIG. 8 is a schematic end view of the electrode assembly of the present invention using an electrode having multiple needle-like tips.

### DETAILED DESCRIPTION OF THE INVENTION

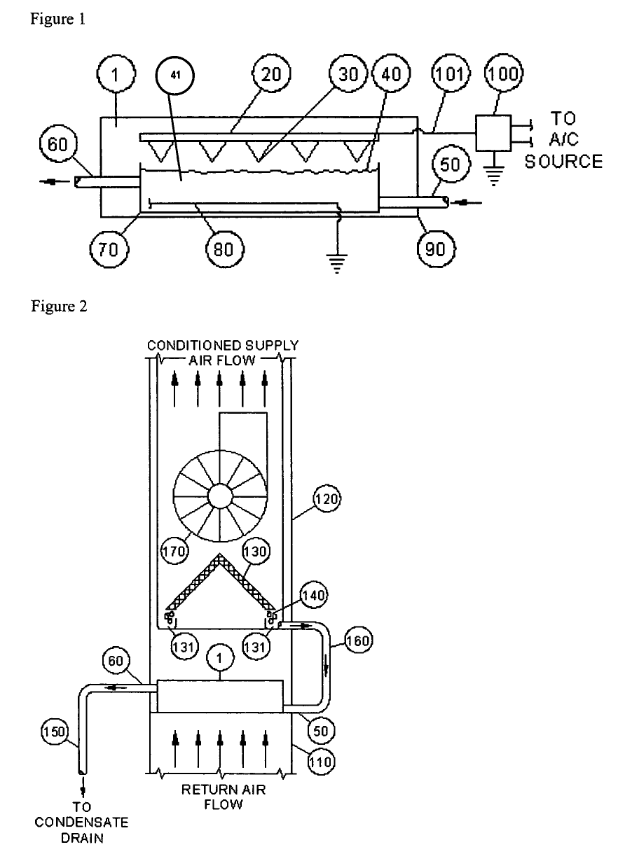

The self cleaning device designated generally by reference numeral 1 in FIG. 1 includes at least one negative air ion generator bar 20 connected to an electrical power supply 100 via insulated conductor 101, at least one ionizing tip 30 and a grounded flowing water body which has a surface 40 approximately perpendicular and proximate to the at least one ionizing tip 30. The water body 41 is contained in an open-topped container 70, which is either electrically conductive and grounded or which contains a grounded electrode 80 located below the surface 40 of the water body 41. The water collection surface 40 of the water body 41 is maintained at the proper spacing from the ionizing tip by the placement of the respective water inlet port 50 and outlet port 60. The outlet port 60 is located at the desired water level so that water will fill the volume of the container 70 and not exit the collector until the water level has reached the elevation of the outlet port 60. In this manner, the water level can be maintained without the need for an active liquid level control or liquid level float switch.

The power supply 100 is a dc power supply for supplying a voltage to the at least one ionizing tip 30 via the insulated conductor 101. The ionizing voltage is selected to be capable of inducing the electrostatic field. This ionizing voltage should be at least about −10 kV DC but higher voltages are preferred. Of course the spacing between the at least one ionizing tip 30 and the surface 40 the grounded flowing water body 41 will have to be increased as the voltage is increased (or as the ionization tip 30 is sharpened), but the larger cross-sectional area between the ionization tip 30 and the water surface 40 will provide increased contaminate and particle capture. Ideally this power source 100 would operate from a 24 volt AC power source, although any input power source could be used. The use of a 24 volt AC power source would simplify the field installed wiring because the device could then be powered from the air conditioner's or heating system's control circuit. Additionally this unit should only operate when the AC (or heating) unit is operating, so this power supply could easily be integrated with the existing control circuitry to operate from the same 24 VAC power supplying power to the AC system's relay (contactor) which activates the air handler of the AC system.

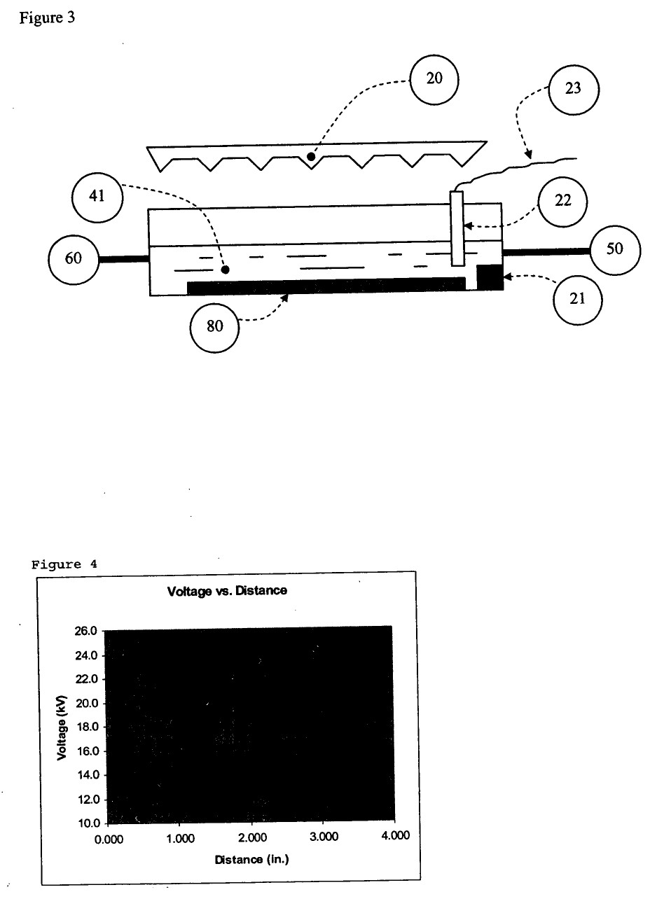

The ground electrode 80 located under the collector water level could be made from any electrically conductive material (such as aluminum, stainless steel, copper, carbon steel, etc.) and optionally it can be made all or in part from a material which has biocide properties such as copper, zinc, silver, tin and the like. We also contemplate the use of a separate metal plate, tablets, or packets containing the biocide metals in the grounded water as shown in FIG. 3 discussed below. The addition of a biocide metal source to the grounded water will inhibit the growth of microorganisms in the device and thereby increase its life, and reduce the likelihood of the condensate lines becoming clogged with biological growth (thereby also removing the need for cleaning the drain line, which otherwise can become clogged). The device will also generate ozone which will have benefits in disinfecting the air which passes through the device while also inhibiting the growth of microorganisms in the water and further reducing the likelihood of the condensate lines becoming clogged with biological growth (thereby also removing the need for cleaning the drain line, which otherwise can become clogged). Of course, as described below and illustrated in FIG. 3, a separate metal with biocide properties could be used in a tablet or packet form 21 which slowly dissolves in the grounded water body 41. Further, an electrode can be used to generate biocide metal ions such as Cu and Ag (See “22” in FIG. 3). With the latter, a low voltage (e.g., less than 30 VDC) can be applied to a 90/10 or 80/20 Cu/Ag electrode, for example, to generate the biocide metals.

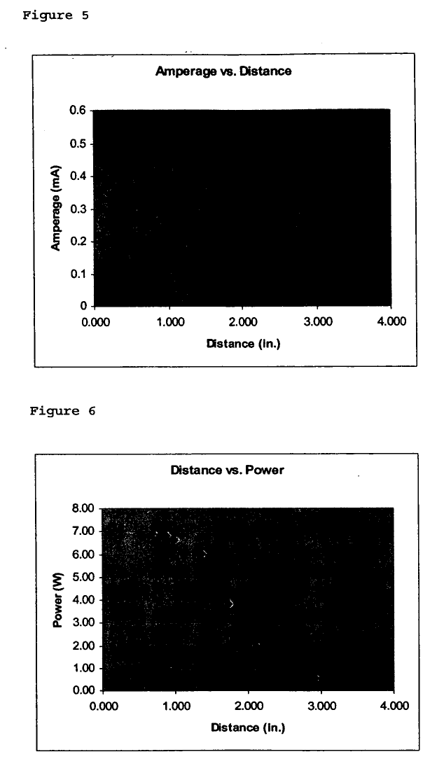

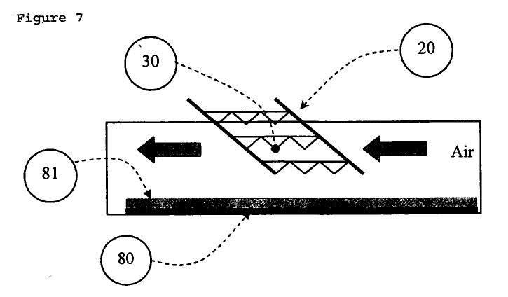

The distance between the ionizing tip 30 and the surface 40 of the water body 41 is selected to minimize arcing while still producing an electrostatic field which generates charged particles capable of reducing air borne contaminants. In one currently preferred embodiment of this invention, this distance is about 0.5 inches to about 3 inches. FIG. 4 shows the variation in electrical voltage as a function of distance between the ion generator bar 20 and the water surface 40 of the grounded water body 41 for the high-voltage power supply of that embodiment. Likewise, FIG. 5 shows the electrical amperage produced by the flowing of negative ions as a function of the distance between the ion generator bar 20 and the water surface 40 of the grounded water body 41 for the high-voltage power supply of FIG. 4. FIG. 6 is a plot of the electrical power consumed to provide the flow of negative ions as a function of distance between the ion generator bar 20 and the water surface 40 of the grounded water body 41 for the same high-voltage power supply of FIG. 4. As the distance between the ion generator bar 20 and the water surface 40 decreases, there results a greater consumption of electrical power, a greater flow of ions into the water, an increased air purification ability and increased generation of ozone. Conversely, as the distance between the ion generator bar 20 and the water surface 40 of the grounded water body 41 increases, there results a reduced consumption of electrical power, a reduced flow of ions into the water, a reduced air purification ability and a reduced generation of ozone.

It is clear from FIGS. 3 through 5 that, at a sufficiently large spacing (just above 3 inches for the power supply used in the embodiment of FIGS. 3-5), there is insufficient electrical potential (voltage) across the gap (that is, the distance between the ion generator bar 20 and the water surface 40 of the grounded water body 41) and there is no flow of ions, essentially no power consumed due to the flowing of ions, no air purification effect and no ozone generation. It is also clear from FIGS. 3 through 5, that at a sufficiently close spacing (just less than 1 inch for the power supply 100 used in the configuration of FIGS. 3-5), arcing occurs across the gap along with excessive power consumption and excessive ozone generation.

In addition to the minimum (arcing) and maximum (no ion flow) gap spacing being dependent on the maximum voltage that can be supplied to the ion generator bar 20 by the power supply 100, the spacing is also dependent on the sharpness of the ionizing tips 30 of the ion generation bar 20. Both sharper ionizing tips 30 and higher maximum output voltages from the power supply 100 will result in increases in the maximum gap between the ion generator bar 20 and the water surface 40 of the grounded water body 41. The ionization tips 30 can be fabricated from electrically conducting alloys that allow carbon nanotubes to be grown on the surfaces of these ionization tips, using, for example, the methods disclosed in U.S. patent application Ser. No. 10/649,793, filed Aug. 28, 2003, and U.S. patent application Ser. No. 10/898, 933, filed Jul. 27, 2004. This nanotube-enhanced ionization tip surfaces provide for very sharp nanometer scale tips, resulting in increased gap spacing and improved performance. Alternatively, the carbon nanotubes can be grown directly on the ionization bar 20, resulting in the formation of numerous ionization tips formed from the carbon nanotubes which project from the surface of the ionization bar.

While this device could be placed anywhere in the air steam of the AC (or heating) system, the preferred location is in the return air duct 110 below the air handler 120, that is below the evaporator 130 and its condensate drain pan 131 as shown in FIG. 2. The existing blower 170 of the existing air handler 120 is used to move the air to be cleaned through the gap formed between the one or more ionization tips 30 and the surface 40 of the grounded water body 41. In this way the condensate 140 draining from the evaporator 130, which is caught in the drain pan 131 and normally flows out the condensate drain line 150, can be plumbed through line 160 through the air cleaning device before flowing to the condensate drain line 150 to be carried to the outside of the building where it is discarded. (Likewise for the heating system the preferred location is below the humidifier, and in this way the excess humidifier water flow, which normally flows out of the system, can drain by gravity through the air cleaning device.) The disinfection of the water in the drain line as a result of the ozone generation or the use of biocide metals or additives in the water body 41 will also prevent biological clogging of this condensate (or humidifier) drain line which is also a common problem.

It is also to be understood, however, that the self cleaning air purification and dust/particulate reduction system generally designated by reference numeral 1 in FIGS. 1 and 2, while exemplified for incorporation into an air conditioning system or a heating system, can be used in any enclosed space where air is circulated and a source of water is available.

The air ion generator bar 20 is made up of one or more ionizer tips 30. While commercial ionizing needles can be utilized, we have found that any conductive sheet stock (stainless steel, copper, aluminum, etc.) can be punched on a conventional sheet metal punch press to form a plurality of tips which can successfully operate as ionization needles or tips. Since these tips are not as sharp as needle ionization tips, the applied voltage must be increased or the spacing between the tips and the grounded water surface decreased, or both. A plurality of sharp ionization tips can also be created by growing carbon nanotubes on a suitable and conductive alloy.

The negative air ion generator 1 is operated at approximately −10,000 to approximately −50,000 volts dc, with approximately −12 kV to −30 kV dc currently preferred. However, any voltage producing space charges which cause reduction of airborne contaminants can be used. The positive air ion generator 1 is operated at approximately +10,000 to approximately +50,000 volts DC, with approximately +12,000 to +30,000. volts DC preferred. However, any voltage producing space charges which cause reduction of airborne contaminants can be used.

The number and length of ionization generator bar 20, that is the number of ionization tips 30 is dependent on the desired rate of contaminant removal, the size of the conditioned space, the air flow rate of the blower 170 used in the air handler 120 of the air conditioning system, the sharpness of the ionization tips 30 and the electrical power limitations of the power supply 100, however anyone skilled in the art could size the system. The capacity to remove contamination and dust/particulate from the air is proportional to the number of ionization tips. The total power required is a function of the number of ionization tips (for a fixed spacing between the ionization tips and the grounded water surface). The power required per ionization tip is dependent on the spacing of the ionization tip from the water surface, and the sharpness of the ionization tip. The ionization tips should always be manufactured as sharp as possible; however this sharpness is limited by the practical cost of the assembly. For example, while needle like tips can be used at spacings of as much as 3 inches from the grounded water surface, we have also found that a sheet metal punched tip, must be closer to the water surface, on the order of 1 to 2.5 inches for a 24 kilovolt power supply, since the tip radius is much larger. One skilled in the art can readily perform the trade off between cost and performance. Nanotube coated tips, significantly reduce the tip radius and are also an ideal method of improving the tip radius significantly without the use of individual needle tips. We contemplate the coating of metals or metal alloys with carbon nanotubes to form the ion generator bar 20 or tips 30 using a method developed by the assignee of this application to grow carbon nanotubes directly on the metals or metal alloys.

Placement of the electrically-grounded free-surface (exposed water surface) of the flowing water in close proximity to the ionization tips 30 creates a strong electrostatic field which in turn charges particles in the vicinity of ionization tips. The air to be cleaned is circulated through the gap between the surface 40 of the grounded water body 41 and the ionization tips 30 by the action of the existing blower in the air handler of the air conditioning or heating system. This blower is energized and operating whenever the air conditioner is providing cooling and dehumidification to the conditioned space (or the heating system and humidifier are providing heating and humidification to the conditioned space).

The distance between the ionizing tip 30 and surface 40 of the water body 41 is selected to minimize arcing while still producing an electrostatic field which generates charged particles capable of reducing air borne contaminants. In one currently preferred embodiment of this invention, this distance is about 1 inch to about 2.5 inches. The ionization tips 30 can be positioned at least as close as possible to the surface 40 of the grounded flowing water body 41 without creating an arc to as far away from the surface 40 of the grounded flowing water body 41 as possible while still maintaining the flow of ions, that is an electrical current (see FIG. 5 for example) which reduce air borne contaminants. The closer the ionization tips 30 (all tips are positioned to be the same distance to the water surface) are to the surface 40 of the grounded flowing water body 41, the stronger the electrostatic field will be and the more effective the dust/particulate removal will be, however, the distance must be far enough apart to prevent arcing. With a power supply 100 voltage of about −10 kV to −50 kV, and when sheet metal punched ionization tips are used, the gap spacing can range from about 0.5 inches apart to as much as about 4 inches.

The grounded flowing water body 41 is formed by using an open-topped electrically conductive container 70 which is electrically-grounded and which includes an inlet and outlet, where the outlet is positioned so as to force the water to accumulate to a predetermined height in the container, before exiting. However, there are many other passive and mechanical ways to achieve this same result, namely the control of the water height to a predetermined level. In our currently preferred embodiment, the grounded flowing water body 41 is formed by using an open-topped electrically insulated container 70 which contains an electrically-grounded electrode, consisting of a conducting plate, rod or sheet 80 inside the container. The grounded electrode 80 located under the collector water surface 40 could be made from any electrically conductive material (such as aluminum, stainless steel, copper, carbon steel, etc.). The container includes an inlet 50 and outlet 60, where the outlet is positioned so as to force the water to accumulate to a predetermined height in the container, before exiting. The container can be fitted with a metal which provides biocide action, or the grounded conducting plate, rod, or sheet 80 can be fabricated from such a biocide material, (zinc, tin, nickel, copper, or silver, or alloys containing these metals, for example). When the grounded flowing water body 41 is formed by using an open-topped electrically conductive container, this container 70 could be fabricated from an electrically conductive biocide material, (zinc, tin, nickel, copper, or silver, or alloys containing these metals, for example).

Referring to FIG. 3, a biocide body 21 could also be added to the water container 70 and submersed in the water body 41. The advantage of using a biocide in the water body 41 is threefold, namely (1) disinfection of the water which can be entrained by the air flow, (2) disinfection and decontamination of the water which flows through the grounded flowing water body 41 which will minimize or eliminate the need to clean the vessel due to fouling and clogging, and (3) improvement of the electrical conductivity of the water. The disinfection and decontamination of the grounded water body 41 in reservoir 70 will minimize or eliminate clogging of the condensate drain line downstream from the air purification device. The biocide body 21 can be comprised of salts containing biocide metals such as silver, zinc, copper, and tin. Body 21 can be in the form of a tablet or packet. Preferred compounds forming body 21 include, but are not limited to oxides, carbonates, stearates, laureates, phosphates, oxalates, fluorides and chlorides containing the metals Ag, Ni, Cu, Zn, and Sn. Powders, small pieces of sheet, or shots of the metals themselves, Ag, Ni, Cu, Zn, and Sn, could also be used as body 21. In addition, chelating agents can be including in body 21 to promote solubility and biocide activity of the metal ions. Chelating agents retain the metal biocides in a free state so that the metal biocides can be metabolized more easily by the microbes in the water. Preferred chelating agents include aminopolycarboxylics such as salicylic acid (SA), ethylenediaminetetraacetic acid (EDTA), nitrilotriacetic acid (NTA), and diethylenetriamine pentaacetic acid (DTPA), and metal salts of these compounds. As depicted in FIG. 3, a metal strip 22 could also be placed in the water which can produce biocide metal ions such as Ag and Cu by applying a low voltage and current through conductor 23. Biocide body 21 and metal strip 22 would not typically be used together, but it is within the scope of this invention to use both of these biocide generators in order to optimize the biocide metal content of the water body 41.

Referring to FIG. 2, the ion generator 30 and the water body container 70 are attached to a nonconductive frame 90. This frame 90 can be of any configuration to support the ion generators and maintain all ionization tips 30 at the same distance from the surface 40 of the grounded flowing water body 41, without impeding the free flow of air between the ionization tips 30 and the moving water surface 40. This frame may have provisions to keep hands, fingers or other body parts from becoming located between the ionization bar 20 and the surface 40. This frame 90 can be constructed of any non-conductive material such as for example nylon, plastic, glass, ceramic, PVC, etc.

This invention can also generate ozone for air disinfection. Ozone is produced when oxygen molecules (O₂) in air are dissociated into oxygen atoms which subsequently collide with an oxygen molecule (O₂) to form an unstable gas, ozone (O₃). Ozone is a known disinfectant, and is generated in this configuration by the high voltage imposed across the gap between the ionization tips 30 and the water surface 40. The smaller the gap or the higher the voltage, the greater the quantity of ozone generated. The preferred voltages of this invention provide for the generation of ozone, which will have the added benefit of purifying the water contained in the grounded flowing water body 41 and air flowing between ionization tips 30 and the water surface 40. The maximum allowable ozone concentration recommended by ASHRAE in an air conditioned and ventilated space is 0.050 ppm, and the maximum allowable ozone concentration in industrial working area is 0.100 ppm, for 8 hours a day, 6 days a week. This device generates static ozone concentrations of about 0.1 ppm which is greatly diluted when placed in an air handling system to concentrations below 0.045 ppm.

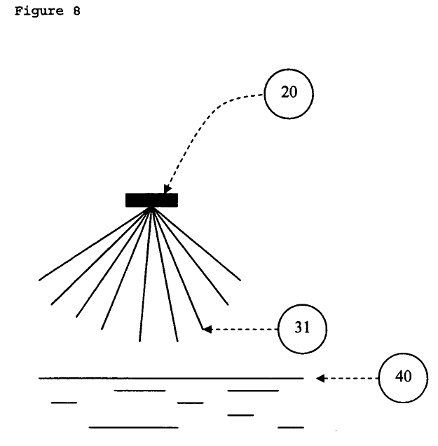

Referring to FIG. 7, a wetted sponge, or any other electrically conductive gel, paste, polymer, adsorbent or absorbent material can also be used in lieu of the three-dimensional water body 41, this alternative three dimensional conductive medium 81 being in electrical contact with the grounding electrode 80. Electrically conductive material such as carbon is also contemplated because it has the added benefit of removing odors. In this embodiment, the three-dimensional electrically conductive medium 81 can be periodically removed, rinsed and placed back into the device. The air can flow between the ionization tips 30 and the medium 81, in contact with grounding electrode 80. The medium 81 can also contain a metal biocide solution that may also contain chelating agents.

Referring to FIG. 8, the ionizing tips 31 can be comprised of multiple wires or needles attached to an ion generation bar 20. The multiple ionizing tips 31 can be assembled so as to be substantially equal distance to the water surface 40, or this distance may vary as depicted in FIG. 8.

The following examples illustrate the use of the invention for reducing airborne particulates in air conditioned spaces without the need to clean a filter or collection media of any type. These examples are intended to further illustrate the invention and are not intended to limit the scope of the invention as defined by the claims. Multiple or expanded units, using the same principles, can be used for reduction of airborne contaminants in larger air conditioned spaces.

### EXAMPLE 1

We tested one embodiment of the above-described self cleaning air cleaner 1 using a power supply which supplied −22.1 kV to six negative air ion generator bars 20. Each bar was approximately 10 inches long, with 19 punched sheet metal ionization tips 30 each having a length of 5/16″, spaced approximately 0.5 inches apart, for a total of 114 ionization tips for the entire assembly. A non-conducting water collection volume 70 was used with a ground electrode 80 located under the surface 40 of the water body 41. The volume of water was 2.5 liters. The ionization tips were located 1.75 inches from the water surface 40. This device was installed in the return air duct of a 3-ton air handler, below the condensate pan. This 3-ton air handler had an air flow rate of approximately 975 CFM. This device was shown to remove between about 0.33 and 0.83 mg/hr of contaminants for 6 hours from air at different times of day, and the power consumed by this self-cleaning air filter, for this configuration, was 3.8 Watts. In separate 24 hour tests in a different location with 1491 CFM air flow, the solids removed ranged from about 0.17 to 0.71 mg/hr.

### EXAMPLE 2

The system of Example 1 was tested with the ionization tips located 2.25 inches from the water surface 40. The volume of water body 41 was 1.8 liters. The voltage on the six negative air ion generator bars 20 was −23.7 kV. This device was shown to remove 0.17 mg/hr of contaminants for 6 hours of air conditioner operation, and the power consumed by this self-cleaning air filter, for this configuration, was 1.9 Watts. A test at a different location with 1491 CFM of air flow removed dust/particulates at about 0.28 mg/hr.

### EXAMPLE 3

The system of Example 1 was tested with the ionization tips located at 1.25 inches from the water surface 40. The voltage on the six negative air ion generator bars 20 was −17.8 kV and an air flow of 975 CFM. This device was shown to remove between about 0.67 and 1.17 mg/hr of contaminants for 6 hours of operation at different times of day. The power consumed was 6.1 Watts. In a separate 24-hour test at a different location with 1491 CFM of air flow, the solids were removed at an equivalent rate of 0.50 mg/hr.

### EXAMPLE 4

A device similar to that described in Example 1 was tested. This device utilized 6 negative air ion generator bars 20. Each bar was approximately 10 inches long, with 15 punched sheet metal ionization tips 30 each having a length of ½″, spaced approximately 11/16 inches apart, for a total of 90 ionization tips for the entire assembly.

### EXAMPLE 5

For the device described in Example 1, the voltages, currents and power were measured as a function of distance between ionization tips and water surface 40. As this electrode-water body distance varied between 0.6 inches and 3 inches, the voltage varied between −12 kV and −25 kV, the amperage varied between 0.5 and 0.02 mA, and the power varied between 7 and 0.5 watts.

### EXAMPLE 6

The ozone generation for the device of Example 1 was measured using test strips. When the distance between the electrode tips and water body was 1.25 inches and a voltage of −19.3 kV, the ozone concentration under static conditions within about 6 inches of the electrode tips was 0.075-0.105 ppm. Under dynamic air cleaner operation this concentration was diluted by the air flow below the ASHRAE maximum allowable concentration of 0.050 ppm in an air conditioned and ventilated space. There was also no measurable peroxide generated and resident in the water body 41.

### EXAMPLE 7

An electrode was fabricated from thin stainless steel wire (approximately 1 mm diameter) and used in the cleaning device. This device consisted of about 104 “needle” electrodes (“31” in FIG. 8) ranging from about 1.5 to 3.5 inches long, on a bar approximately 10 inches long. FIG. 8 depicts an end view of this electrode assembly 20. The closest spacing between the needle electrode tips 31 and the water body surface 40 was 1.25 inches. The voltage was −19.3 kV, and solids were collected in the 1.6 liter water body 41 at a rate of 0.58 mg/hr over a period of 24 hours.

### EXAMPLE 8

A biocide tablet was added to the system described in example 3. The biocide tablet was comprised of 22.1% salicylic acid, 66.2% EDTA, 0.5% AgO, 6.2% CuO, 4% stearic acid, and 1% magnesium stearate.

### EXAMPLE 9

We also tested the system used in Example 1 and compared the dust/particulate collection as a function of the number of negative air ion generator bars 20. In the first 48-hour test with six bars, the starting voltage was −21.9 kV (the ionization tips were 1.75″ from the water surface 40) and the rate of dust/particulate collection was 0.21 mg/hr. In a similar test with eleven negative air ion generator bars 20, the starting voltage was −21.6 kV and the rate of dust/particulate collection was 0.25 mg/hr over a period of 32 hours.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed:

1. An apparatus, comprising:
at least one ionizing device having at least one ionizing tip at a first electric potential; and
a defined body of grounded, unrecirculated water forming an exposed surface in a predetermined relationship to the at least one ionizing tip, which surface is at a second electric potential different from the first electric potential.

2. The apparatus of claim 1, wherein a grounding surface is located under the body of grounded water.

3. The apparatus of claim 2, wherein the body of grounded, unrecirculated water is flowing water in electrical contact with the grounding surface.

4. The apparatus of claim 2, wherein the surface of the body of grounded, unrecirculated water is substantially perpendicular to the at least one of the ionizing tip.

5. The apparatus of claim 1, wherein at least one of the ionizing device and the ionizing tip have a carbon nanotube-coated surface.

6. The apparatus of claim 1, wherein the at least one ionizing device is a bar supported by a non-conductive frame.

7. The apparatus of claim 1, wherein a non-conductive frame is provided for supporting the at least one ionizing device.

8. The apparatus of claim 1, wherein the electric potential difference is between one of about −10 and −50 kV and about 10 and 50 kV.

9. The apparatus of claim 1, wherein the at least one ionizing tip and the surface are spaced at a distance of between about 0.5 and 4.0 inches.

10. The apparatus of claim 1, further comprising metal biocide material for keeping the grounded water clean and for disinfecting entrained moisture in air flow through a system with which the apparatus is associated.

11. The apparatus of claim 8, wherein the metal biocide material is selected so as to increase the electrical conductivity of the grounded water.

12. The apparatus of claim 10, wherein the system is an air conditioning system.

13. The apparatus of claim 10, wherein the system is a forced-air heating system.

14. The apparatus of claim 1, wherein the electrical potential difference is of a magnitude sufficient to generate ozone concentrations for disinfecting air flowing at the apparatus.

15. The apparatus of claim 1, wherein the body of grounded, unrecirculated water is fed by one of gravity or mechanically.

16. The apparatus of claim 2, wherein the grounding surface is an electrically conductive plate.

17. The apparatus of claim 2, wherein the grounding surface is one of a plate, rod, or sheet made of at least one material selected from the group consisting silver, copper, zinc, nickel, and alloys containing silver, copper, zinc, tin, nickel, stainless steel, carbon steel and aluminum.

18. The apparatus of claim 1, wherein the at least one ionizing device and the at least one ionizing tip are made of electrically conductive material.

19. The apparatus of claim 1, further comprising a power supply for generating the electric potential difference between the at least one ionizing tip and the surface.

20. The apparatus of claim 1, wherein a preexisting air conditioner or heating system control circuit is operatively configured to power the at least one ionizing device.

21. The apparatus of claim 1, wherein a power supply with low-voltage input power is operatively connected with the at least one ionizing device.

22. A purification apparatus, comprising at least one ionizing device having at least one ionizing tip, a wetted absorbent or adsorbent material arranged in a desired relationship to the a least one ionizing tip, and a grounding surface located under the material and in electrical contact therewith such that a voltage difference exists between the at least one ionizing tip and the grounding surface.

23. The apparatus of claim 22, wherein the wetted absorbent or adsorbent material is substantially perpendicular to the at least one ionizing tip.

24. The apparatus of claim 22, wherein the material is a three-dimensional medium containing metal biocide material and optionally at least one chelating agent.

25. The apparatus of claim 22, wherein a non-conductive frame is provided for supporting the at least one ionizing device in the form of an ionizing bar.

26. A purifying apparatus, comprising
at least one ionizing device having at least one ionizing tip;
a grounding surface arranged at a electrical potential different from the at least one tip; and
an electrically conductive medium arranged to hold captured dust and particulates, the medium being in electrical contact with the grounding surface and arranged in a predetermined relationship to a direction in which the at least one ionizing tip is aligned.

27. The apparatus of claim 26, wherein the medium is substantially perpendicular to said direction.

28. The apparatus of claim 26, wherein the conductive medium is comprised of one of carbon or one of a three-dimensional wetted sponge, gel, paste, polymer, water or wetted body.

29. The apparatus of claim 26, wherein the conductive medium is one of an absorbent and adsorbent material.

30. Self-cleaning apparatus for purifying gas media, comprising
at least one ionizing device having at least one ionizing tip;
a conductive surface; and
a grounding surface located under the conductive surface and being at an electrical potential different from the at least one ionizing tip and in electrical contact with the conductive surface.

31. The apparatus of claim 30, wherein a non-conductive frame is provided for supporting the at least one ionizing device configured as an ionizing bar.

32. The apparatus of claim 10, wherein the metal biocide material is generateable by a silver and copper electrode.

33. The apparatus of claim 10, wherein the metal biocide material is generateable by a slowly dissolving tablet or packet that optionally contains at least one chelating agent.

34. A method for purifying flowing gas, comprising
arranging a defined body of grounded, unrecirculated conductive medium forming an exposed surface on a predetermined relationship to one or more ionizing tips, and
generating an electrical potential difference between the one or more ionizing tips and the exposed surface.

35. The method of claim 34, further comprising using biocides and optionally chelating agents to disinfect unrecirculated conductive medium and moisture entrained in the gas flow.

36. The method of claim 35, further comprising carbon nanotube coating.

37. The method of claim 35, further comprising generating ozone to disinfect the purified gas.

38. The method of claim 35, further comprising removing at least one of mold spores, fungi, virus and bacterium from the gas.
